(19) United States
(12) Patent Application Publication
(10) Pub. No.: US 2025/0317167 A1
(43) Pub. Date: Oct. 9, 2025

(54) METHOD AND APPARATUS FOR FORMING COMMUNICATION CHANNEL IN MULTIPLE INPUT MULTIPLE OUTPUT SYSTEM

(71) Applicant: SEOUL NATIONAL UNIVERSITY R&DB FOUNDATION, Seoul (KR)

(72) Inventors: Byonghyo SHIM, Seoul (KR); Seungnyun KIM, Seoul (KR); Jungjae PARK, Seoul (KR)

(21) Appl. No.: 19/246,821

(22) Filed: Jun. 24, 2025

Related U.S. Application Data
(63) Continuation of application No. PCT/KR2024/000021, filed on Jan. 2, 2024.

(30) Foreign Application Priority Data
Dec. 30, 2022 (KR) 10-2022-0190579
Mar. 17, 2023 (KR) 10-2023-0034947

(51) Int. Cl. H04B 7/0413; H04B 7/0408; H04B 17/11; H04L 5/00

(52) U.S. Cl. CPC H04B 7/0413; H04B 7/0408; H04B 17/11; H04L 5/0048

(57) ABSTRACT

According to an embodiment, a communication channel formation method includes: transmitting, by a base station server, a pilot signal to a terminal through transmission beams directed in different directions; receiving, by the terminal, the pilot signal through reception beams directed in different directions and measuring the magnitudes of the pilot signal received through the reception beams; matching the transmission beams with the reception beams to set transmission-reception beam indices based on the magnitudes of the pilot signal; determining, by the terminal, an optimal reception beam among the reception beams based on the transmission-reception beam indices; and determining, by the base station server, an optimal transmission beam among the transmission beams based on the transmission-reception beam indices received from the terminal, thereby forming a channel between the base station server and the terminal.

### CROSS-REFERENCE TO RELATED APPLICATION

This application is a continuation of International Application No. PCT/KR2024/000021 filed on Jan. 2, 2024, which claims priority to Korean Patent Application No. 10-2023-0034947, filed on Mar. 17, 2023, which claims priority to Korean Patent Application No. 10-2022-0190579, filed on Dec. 30, 2022, the entire contents of which are herein incorporated by reference.

### BACKGROUND

### 1. Field

The present invention relates to a method and apparatus for forming a communication channel in a multiple input multiple output (MIMO) system, and more particularly, to a method and apparatus for forming transmit and receive beams oriented in different directions based on a phase shifter and a real-time time delay unit, and for setting an optimal transmit beam and an optimal receive beam based on the magnitude of a pilot signal.

### 2. Description of the Related Art

In a multiple-input multiple-output (MIMO) system operating in the millimeter-wave and terahertz frequency bands, the system performance is highly sensitive to the direction of the beams formed at both the base station and the mobile user. Therefore, beam management to find a transmit-receive beam pair that forms an optimal communication channel is essential prior to data communication in MIMO systems.

In conventional beam management, beams are formed using only phase shifters, allowing the transmission of a pilot signal in only one direction per time slot. As a result, the time required to form an optimal transmit-receive beam pair increases proportionally to the product of the number of beams at the base station and the number of beams at the mobile user.

Furthermore, a base station and mobile user with a millimeter-wave/terahertz link must repeatedly perform the beam management process to maintain the transmit-receive beam pair that forms the optimal channel, resulting in excessive time and network resource consumption.

Accordingly, research is needed on technologies that can form a number of subcarrier beams simultaneously corresponding to the number of subcarriers and reduce the time and network resources required to find the optimal beam pair between the base station and the terminal.

### SUMMARY

The present disclosure is intended to solve the aforementioned problems of the prior art. It aims to provide a method and apparatus for forming transmit and receive beams directed in different directions based on a phase shifter and a real-time time delay unit, and for setting the optimal transmit beam and optimal receive beam based on the magnitude of a pilot signal.

The technical problems to be solved by the present invention are not limited to those described above, and other technical problems may be derived from the following description.

As a technical means for solving the above-described technical problems, an embodiment according to a first aspect of the present disclosure provides a method for forming a communication channel. The method includes: transmitting, by a base station server, pilot signals to a terminal through transmit beams directed in different directions; receiving, by the terminal, the pilot signals through receive beams directed in different directions, measuring the magnitudes of the pilot signals received through the receive beams, and matching the transmit beams and the receive beams to establish transmit-receive beam indexes based on the magnitudes of the pilot signals; and determining, by the terminal, an optimal receive beam among the receive beams based on the transmit-receive beam indexes, and determining, by the base station server, an optimal transmit beam among the transmit beams based on the transmit-receive beam index information received from the terminal, thereby forming a channel between the base station server and the terminal.

In addition, an embodiment according to a second aspect of the present disclosure provides a communication channel formation system. The system includes a base station server and a terminal. The base station server transmits pilot signals to the terminal through transmit beams directed in different directions. The terminal receives the pilot signals through receive beams directed in different directions, measures the magnitudes of the received pilot signals, and matches the transmit and receive beams to establish transmit-receive beam indexes based on the magnitudes of the pilot signals. The terminal determines an optimal receive beam among the receive beams based on the transmit-receive beam indexes, and the base station server receives the transmit-receive beam index information from the terminal and determines an optimal transmit beam among the transmit beams, thereby forming a channel between the base station server and the terminal.

Furthermore, an embodiment according to a third aspect of the present disclosure provides a method for forming a communication channel, performed by a base station server. The method includes: transmitting pilot signals to a terminal through transmit beams directed in different directions; and receiving index information generated by the terminal connected to the base station server, determining an optimal transmit beam among the transmit beams based on the index information, and forming a channel between the base station server and the terminal. The index information is a transmit-receive beam index established by the terminal based on the measured magnitudes of the pilot signals received through receive beams directed in different directions and matched with the transmit beams.

In addition, an embodiment according to a fourth aspect of the present disclosure provides a base station server of a communication channel formation system. The base station server includes a communication module for transmitting and receiving information with a terminal, a memory storing a communication channel formation program, and a processor executing the communication channel formation program. The server is configured to transmit pilot signals to the terminal through transmit beams directed in different directions, receive index information generated by the terminal connected to the base station server, and determine an optimal transmit beam among the transmit beams based on the index information, thereby forming a channel between the base station server and the terminal. The index information refers to a transmit-receive beam index established by the terminal based on the magnitudes of the pilot signals received through receive beams directed in different directions and matched with the transmit beams.

According to the present invention, by simultaneously generating beams directed in different directions, the terminal's search time can be reduced.

In addition, according to the present invention, by simultaneously generating beams directed in different directions, it is possible to search in multiple directions at the same time.

The effects of the present invention are not limited to the aforementioned effects, and include all effects that can be understood from the following description.

### BRIEF DESCRIPTION OF THE DRAWINGS

FIG. 1 is a diagram illustrating a communication channel formation system according to an embodiment of the present invention.

FIG. 2 is a diagram showing the detailed configuration of the base station server illustrated in FIG. 1.

FIG. 3 is a diagram illustrating the structure of the base station server illustrated in FIG. 1.

FIG. 4 is a diagram showing an example in which the base station server illustrated in FIG. 1 generates transmission beams in different directions.

FIG. 5 is a flowchart illustrating a procedure of a communication channel formation method using a communication channel formation system according to another embodiment of the present invention.

FIGS. 6 to 8 are diagrams showing detailed steps of some steps of the communication channel formation method illustrated in FIG. 5.

FIG. 9 is a flowchart illustrating a procedure of a communication channel formation method of the base station server of a communication channel formation system according to another embodiment of the present invention.

FIG. 10 is a diagram showing detailed steps of some steps of the communication channel formation method illustrated in FIG. 9.

### DETAILED DESCRIPTION

Hereinafter, the present disclosure will be described in detail with reference to the accompanying drawings. However, the present disclosure may be embodied in various different forms and is not limited to the embodiments described herein. The attached drawings are provided to facilitate understanding of the embodiments disclosed in this specification and should not be construed as limiting the technical spirit of the present disclosure. All terms used herein, including technical and scientific terms, shall be interpreted according to the meanings commonly understood by those skilled in the art to which this disclosure pertains. Predefined terms shall be interpreted as having meanings consistent with related technical documents and the context of the current disclosure, and shall not be interpreted as having overly idealized or restrictive meanings unless otherwise defined.

For clarity, parts not relevant to the explanation of the present disclosure are omitted in the drawings, and the size, shape, and form of each component shown in the drawings may be variously modified. Throughout the specification, the same or similar reference numerals are assigned to the same or similar parts.

In the following description, the suffixes “module” and “unit” attached to component names are provided or mixed merely for ease of drafting the specification, and they do not have distinct meanings or roles. Also, in explaining the embodiments disclosed in this specification, detailed descriptions of well-known technologies related to the present disclosure may be omitted if they are deemed to obscure the gist of the embodiments.

Throughout the specification, when a part is referred to as being “connected (joined, in contact, or coupled)” to another part, it includes not only cases where they are “directly connected (joined, in contact, or coupled)” but also cases where they are “indirectly connected (joined, in contact, or coupled)” via another element in between. Also, when a component is said to “include (comprise or have)” another component, unless specifically stated otherwise, it does not exclude the presence of additional components.

The ordinal terms such as “first” and “second” used in the specification are solely for distinguishing one element from another and do not limit the order or relationship of the elements. For example, a “first” component may be referred to as a “second” component, and likewise, a “second” component may be referred to as a “first” component. The singular forms used in the specification are intended to include plural forms as well, unless the context clearly indicates otherwise.

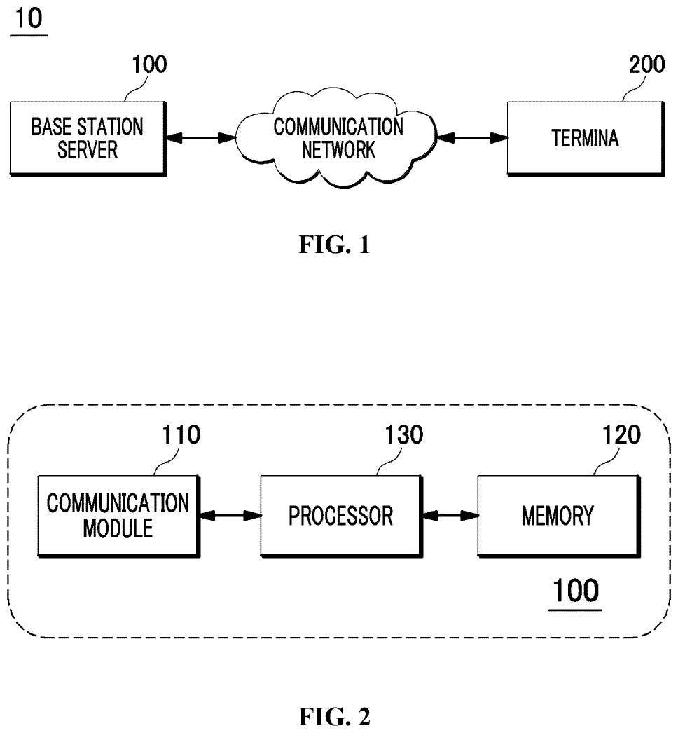

FIG. 1 is a diagram illustrating a communication channel formation system according to an embodiment of the present invention.

Referring to FIG. 1, the communication channel formation system (10) includes a base station server (100) and a terminal (200).

The base station server (100) may refer to an advanced base station (ABS), a high reliability base station (HR-BS), a small base station, a Node B, an evolved Node B (eNodeB), an access point (AP), a radio access station (RAS), a base transceiver station (BTS), a mobile multihop relay base station (MMR-BS), a relay station (RS) performing the role of a base station, or a high reliability relay station (HR-RS) performing the role of a base station. It may include all or part of the functions of BS, ABS, HR-BS, small base stations, Node B, eNodeB, AP, RAS, BTS, MMR-BS, RS, and HR-RS.

The base station server (100) transmits a pilot signal to the terminal through transmission beams directed in different directions.

The base station server (100) receives index information generated by the terminal. Based on the index information, the base station server (100) determines the optimal transmission beam among the transmission beams directed in different directions and establishes a channel between the base station server (100) and the terminal (200). Here, the index information refers to a transmit-receive beam index determined by the terminal (200) by receiving the pilot signal through receive beams directed in different directions, measuring the magnitude of the received pilot signal, and matching the transmission and receive beams based on the signal magnitude.

The terminal (200) receives the pilot signal through receive beams directed in different directions and measures the magnitude of the pilot signals received through the respective receive beams. The terminal (200) sets transmit-receive beam indices based on the signal magnitude by matching the transmission and receive beams.

The terminal (200) may generate receive beams directed in different directions. For example, the terminal (200) may include an analog part composed of a plurality of phase shifters. The terminal (200) may provide a phase shift of θ through the phase shifters.

The terminal may form M receive beams

$${\{ {w}_{m} \}}_{m = 1}^{M}$$

directed within an angular range of [ϕₘᵢₙ, ϕₘₐₓ]. The direction of the receive beamforming vector wₘ in the m time slot may be as shown in Equation 1.

$$\overline{{ϕ}_{m}} = {ϕ}_{min} + \frac{m - 1}{M - 1} ( {ϕ}_{max} - {ϕ}_{min} ) \qquad [ Equation 1 ]$$

Here, ϕ may be the angle of arrival (AoA) of the Line-of-Sight (LoS) path.

The terminal (200) may receive a pilot signal transmitted by the base station server (100) through the reception beams directed in different directions. For example, the pilot signal received by the terminal (200) may be expressed by Equation 2.

$$\text{?} = {w}_{m}^{H} H \text{?} f \text{?} + {w}_{m}^{H} {n}_{m , i} \qquad [ Equation 2$$

$$\text{?} \text{indicates text missing or illegible when filed}$$

Here, Wm is the receive beam, ƒi is the subcarrier frequency, and Hi may represent the downlink channel at frequency ƒi between the base station server (100) and the terminal (200).

The terminal (200) may measure the magnitude of the pilot signal. For example, the magnitude of the pilot signal may be expressed by Equation 3.

$${RSRP}_{m , i} = {\vert \text{?} \vert}^{2} \qquad [ Equation 3 ]$$

$$\text{?} \text{indicates text missing or illegible when filed}$$

The terminal (200) may measure the magnitude of pilot signals for SM beam pairs over the entire M time slots as shown in Equation 3. Here, S may denote the number of transmit beams.

The terminal (200) may match the transmit beam corresponding to the pilot signal with the receive beam that received the pilot signal.

The terminal (200) may set transmit-receive beam indices for the matched transmit and receive beams based on the magnitude of the pilot signal received by the receive beam.

The terminal (200) may determine the transmit-receive beam index with the largest pilot signal magnitude, as shown in Equation 4.

$$\begin{matrix}( m \text{?} \cdot i \text{?} ) = arg {max}_{m , i} {RSRP}_{m , i} \text{?} & m = 1 , …\end{matrix} , M , i = 1 , … , S \qquad [ Equation 4 ]$$

$$\text{?} \text{indicates text missing or illegible when filed}$$

Here, argmaxm,i may denote the values of (m,i) that maximize the function ƒ(m,i) ith respect to m and i.

The terminal (200) may set the receive beam, which corresponds to the direction of the receive beam index among the transmit-receive beam indices, as the optimal receive beam.

The terminal (200) may substitute m* into m in Equation 1 to calculate the direction corresponding to the optimal receive beam index and set the receive beam pointing in that direction as the optimal receive beam.

The terminal (200) may transmit the transmit beam index, among the transmit-receive beam indices, to the base station server (100).

Additionally, the communication network illustrated in FIG. 1 may be implemented as any type of wired or wireless network, such as a Local Area Network (LAN), a Wide Area Network (WAN), a Value Added Network (VAN), a mobile radio communication network, or a satellite communication network.

FIG. 2 is a diagram illustrating the detailed configuration of the base station server shown in FIG. 1.

Referring to FIG. 2, the base station server includes a communication module (110), a memory (120), and a processor (130).

The communication module (110) can transmit and receive information with the terminal. For example, the communication module (110) may transmit a pilot signal to the terminal through a transmit beam and receive the transmit beam index (among the transmit-receive beam indices) from the terminal.

The memory (120) stores the communication channel formation program. The memory (120) should be interpreted as a general term for non-volatile storage devices that retain stored information even without power supply, as well as volatile storage devices that require power to maintain stored information.

Additionally, the memory (120) may function to temporarily or permanently store data and may include magnetic storage media or flash storage media in addition to volatile memory requiring power to retain information. However, the scope of the present invention is not limited thereto.

The processor (130) executes the communication channel formation program. The name of the communication channel formation program is designated for the sake of description and does not limit the function of the program itself. It may be named in various ways.

The processor (130) transmits subcarriers from the base station server to the terminal, and the number of subcarriers may be preset.

The processor (130) may generate a number of transmit beams equal to the number of subcarriers using phase shifters and real-time delay units, taking into account the number of subcarriers.

The processor (130) transmits pilot signals to the terminal through transmit beams directed in different directions. For example, the processor (130) may transmit pilot signals to the terminal through transmit beams directed in different directions using the base station server's phase shifters and real-time delay units. The pilot signal may be a type of subcarrier for forming a communication channel between the base station server and the terminal.

Additionally, the processor (130) may calibrate at least one of the direction and strength of the transmit beams directed in different directions using the real-time delay unit of the base station server. For example, when the processor (130) provides a pilot signal via a transmit beam in the 90-degree direction from the base station server, it may calibrate the beam direction so that the transmit beam is directed exactly toward 90 degrees.

The processor (130) receives index information formed by the terminal. Based on the index information, the processor (130) determines the optimal transmit beam from among the transmit beams directed in different directions and forms a channel between the base station server and the terminal. Here, the index information may be an index of a transmit-receive beam pair, which is formed by the terminal by matching the transmit beam corresponding to the pilot signal with the receive beam that received the pilot signal, and set based on the magnitude of the pilot signal received by the receive beam.

For example, the processor (130) may set the transmit beam directed in the direction corresponding to the transmit beam index (from the transmit-receive beam index transmitted by the terminal) as the optimal transmit beam. The processor (130) may form a channel between the base station server and the terminal located in the direction of the optimal transmit beam.

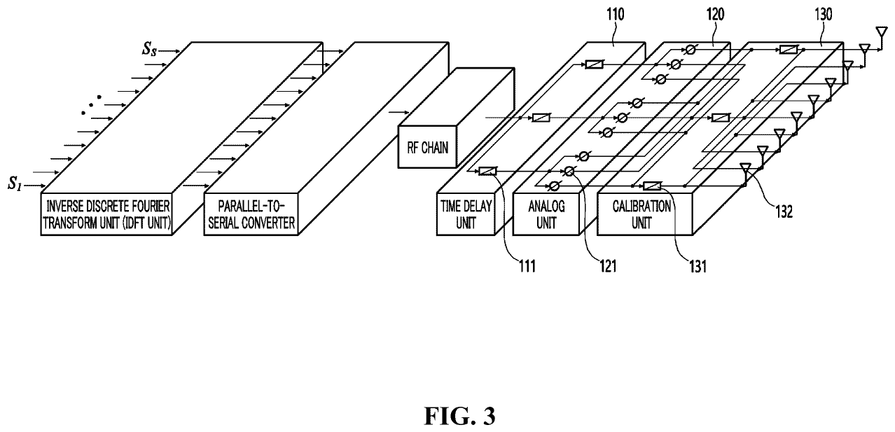

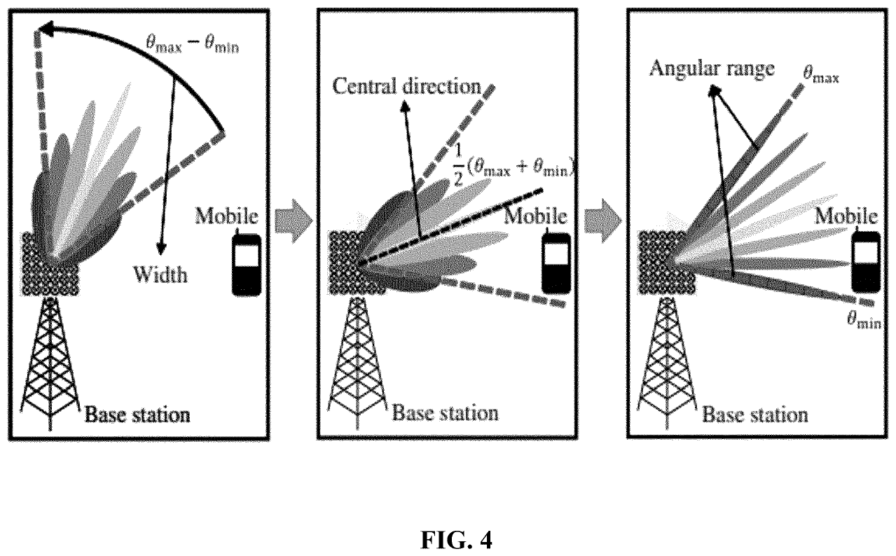

FIG. 3 is a diagram illustrating the structure of the base station server shown in FIG. 1. FIG. 4 is a diagram showing an example in which the base station server shown in FIG. 1 generates transmit beams directed in different directions.

Referring to FIGS. 3 and 4, the downlink channel Hi at subcarrier frequency ƒi between the base station server and the terminal is expressed by Equation 5. For convenience of explanation, Equation 5 may be a model based on a Line-of-Sight (LoS) path.

$${H}_{i} = \text{?} a \text{?} ( ϕ ) {a}_{{N}_{t}} ( θ ) \qquad [ Equation 5 ]$$

$$\text{?} \text{indicates text missing or illegible when filed}$$

Here, gi is the path gain at the subcarrier frequency ƒi, θ and ϕ are the angle of departure (AoD) and angle of arrival (AoA) of the LoS (Line-of-Sight) path, respectively, and aNt(θ) and aNt(ϕ) may be direction vectors defined according to Equations 6 and 7 below.

$${a}_{{N}_{t}} ( θ ) = {⌈ \begin{matrix}1 & {e}^{j θ} & … & {e}^{j θ ( {N}_{t} - 1 )}\end{matrix} ⌉}^{T} \qquad [ Equation 6 ]$$

$${a}_{{N}_{r}} ( θ ) = {⌈ \begin{matrix}1 & e \text{?} & … & {e}^{j θ ( {N}_{r} - 1 )}\end{matrix} ⌉}^{T} \qquad [ Equation 7 ]$$

$$\text{?} \text{indicates text missing or illegible when filed}$$

The base station server may be equipped with uniformly spaced antennas. The base station server may include an inverse discrete Fourier transform (IDFT) unit, a parallel-to-serial converter, an RF chain, a time delay unit (110), an analog unit (120), and a calibration unit (130).

The IDFT unit may convert frequency-domain signals into time-domain signals.

The parallel-to-serial converter may multiplex a high data rate stream into multiple lower-bit-rate streams.

The RF chain may convert digital signals processed by the baseband system into radio frequency (RF) signals for wireless transmission. Additionally, the RF chain may upconvert signals from baseband frequencies to carrier frequencies.

In an OFDM system composed of a bandwidth B, a carrier frequency ƒc, and N subcarriers, the transmit beamforming vector for the i-th subcarrier, which satisfies ƒi=ƒ/c+B/N(i−(N+1)/2) is given by Equation 8.

$${f}_{i} = f \text{?} ( \text{?} ) ⊙ {f}^{A} ( {θ}^{A} ) ⊙ f \text{?} ( \text{?} ) \qquad [ Equation 8 ]$$

$$\text{?} \text{indicates text missing or illegible when filed}$$

Here,

$$f \text{?} ( \text{?} ) ∈ C \text{?}$$

$$\text{?} \text{indicates text missing or illegible when filed}$$

is the beamforming vector of the calibration unit and is given by Equation 9.

$$\text{?} ( \text{?} ( = {[ \begin{matrix}1 & 1 & … & 1\end{matrix} ]}^{T} {\text{?} [ \begin{matrix}1 & e \text{?} & … & e \text{?}\end{matrix} ]}^{T} \qquad [ Equation 9 ]$$

$$\text{?} \text{indicates text missing or illegible when filed}$$

f^{A}(θ)∈ [symbol] is the beamforming vector of the analog unit and is given by Equation (10).

$${f}^{A} ( {θ}^{A} ) = {[ \begin{matrix}1 & e \text{?} & … & e \text{?}\end{matrix} ]}^{T} \qquad [ Equation 10 ]$$

$$\text{?} \text{indicates text missing or illegible when filed}$$

f^{A}(θ)∈ [symbol] is the beamforming vector of the time delay unit and is given by Equation (11).

$$f \text{?} = {[ \begin{matrix}1 & e \text{?} & … & e \text{?}\end{matrix} ]}^{T} ⊗ {[ \begin{matrix}1 & 1 & … & 1\end{matrix} ]}^{T} \qquad [ Equation 11 ]$$

$$\text{?} \text{indicates text missing or illegible when filed}$$

The time delay unit (110) may include T real-time delay elements (111). The base station server may generate multiple time-shifted signals from a single signal using the real-time delay elements (111). For example, the time delay unit (110) may include three real-time delay elements (111).

The time delay unit (110) may generate multiple transmission beams by controlling the time delay.

The time delay unit (110) may provide a time delay of Δt through the real-time delay elements (111). Here, Δt may be calculated by Equation (12) below.

$${τ}^{T} = \frac{{θ}_{min} - {θ}_{max}}{2 π B} \qquad [ Equation 12 ]$$

The analog unit (120) may include Nt phase shifters (121). The base station server may form a plurality of transmission beams oriented in different directions using the phase shifters (121). For example, the analog unit (120) may include nine phase shifters (121), and three phase shifters (121) may be connected to a single real-time delay element (111).

The analog unit (120) may adjust the phase shift θ to maintain the beamwidth of the generated beam while setting the central direction to ½ (θmin+θmax).

The analog unit (120) may provide a phase shift of Δθ through the phase shifter (121), where Δθ may be calculated according to Equation (13) below.

$$θ = \frac{f \text{?} {θ}_{min} - {f}_{1} {θ}_{max}}{B} \qquad [ Equation 13 ]$$

$$\text{?} \text{indicates text missing or illegible when filed}$$

The calibration unit (130) may include P calibrators (131), and each calibrator (131) may be connected to multiple antennas (132). Here, the calibrator (131) may be the same as or similar to the real-time delay element (111) of the time delay unit (110).

For example, the calibration unit (130) may include three calibrators (131) and be connected to nine antennas (132). Each calibrator (131) of the calibration unit (130) may be connected to a different phase shifter (121) of each of the three pairs of three phase shifters (121) connected in sets. Among the nine antennas (132), three antennas (132) may be connected to the first calibrator (131), another three antennas (132) to the second real-time delay element (131), and the remaining three antennas to the third real-time delay element (131).

In other words, if the number of antennas is X, the number of real-time delay elements (111) in the time delay unit (110) may be √X, and the number of calibrators (131) in the calibration unit (130) may also be √X. However, this is not limited thereto. For example, if there are 256 antennas, the number of real-time delay elements (111) in the time delay unit (110) may be 32, and the number of calibrators (131) in the calibration unit (130) may be 8, such that the product of the number of real-time delay elements (111) and the number of calibrators (131) equals the number of antennas.

The calibration unit (130) may correct at least one of the direction and magnitude of transmission beams oriented in different directions using the calibrators (131). For example, the calibration unit (130) may adjust the delay time to correct the gap between the transmission beam and a target transmission beam in the desired direction. The calibration unit (130) may correct the transmission beam that has passed through the time delay unit (110) and the analog unit (120) so that it matches the target transmission beam.

The calibration unit (130) may provide a time delay of Δτ through the calibrator (131), where Δτ may be calculated according to Equation (14) below.

$$τ \text{?} = \frac{P ( {θ}_{min} - {θ}_{max} )}{2 π B} \qquad [ Equation 14 ]$$

$$\text{?} \text{indicates text missing or illegible when filed}$$

The base station server may form [symbol] transmission beams

$$\{ {f}_{i} \} \text{?}$$

$$\text{?} \text{indicates text missing or illegible when filed}$$

oriented in the angular range of [θₘᵢₙ, θₘₐₓ]. Here, the direction of the transmission beamforming vector ƒi for the i-th subcarrier may be as shown in Equation (15) below.

$$\overline{θ} = {θ}_{min} + \frac{i - 1}{S - 1} ( {θ}_{max} - {θ}_{min} ) \text{?} \qquad [ Equation 15 ]$$

$$\text{?} \text{indicates text missing or illegible when filed}$$

The base station server may generate a transmission beam ƒi directed toward the direction calculated by Equation 11 and transmit a pilot signal to the terminal via the transmission beam ƒi.

The base station server may set the transmission beam directed toward the direction corresponding to the transmission beam index, among the transmit/receive beam indices determined by the terminal according to Equation 4, as the optimal transmission beam.

The base station server may calculate the direction corresponding to the optimal transmission beam index by substituting i* into i in Equation 15, and set the transmission beam directed toward the calculated direction as the optimal transmission beam.

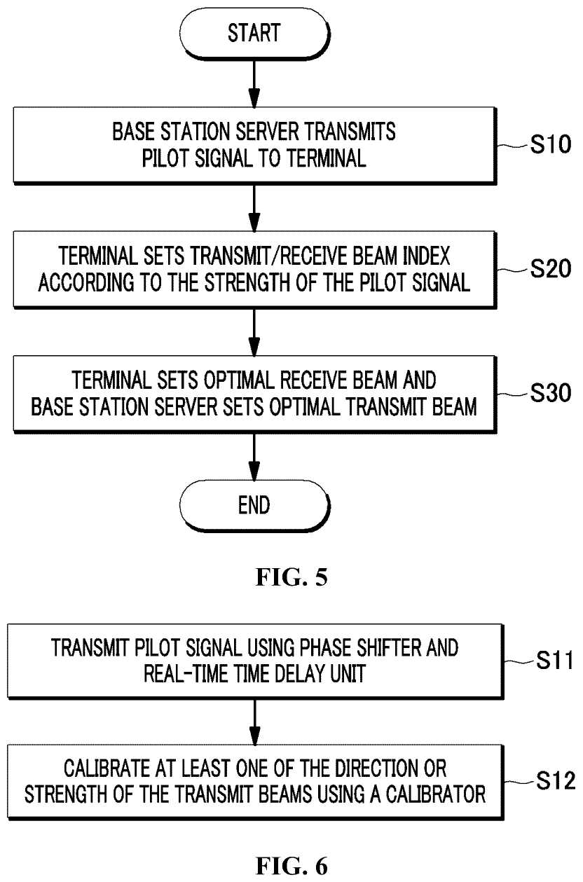

FIG. 5 is a flowchart illustrating a procedure of a communication channel formation method using the communication channel formation system according to another embodiment of the present invention.

The communication channel formation method described below may be performed by the communication channel formation system (10 in FIG. 1) described with reference to FIGS. 1 to 4. Accordingly, the contents of the embodiments described with reference to FIGS. 1 to 4 can also be equally applied to the embodiment described below, and any redundant descriptions will be omitted. The steps described below do not necessarily have to be performed in the stated order; the order may be varied, and some steps may be performed almost simultaneously.

Referring to FIG. 5, the communication channel formation method includes: a step (S10) in which the base station server transmits a pilot signal to the terminal, a step (S20) in which the terminal sets transmit/receive beam indices based on the magnitude of the pilot signal, and a step (S30) in which the terminal sets the optimal receive beam and the base station server sets the optimal transmit beam.

The step (S10) in which the base station server transmits a pilot signal to the terminal refers to the base station server transmitting the pilot signal to the terminal through transmission beams directed in different directions. For example, in the step (S10), the base station server may use phase shifters and real-time delay units to transmit pilot signals to the terminal via transmission beams directed in different directions.

The step (S20) in which the terminal sets the transmit/receive beam indices based on the magnitude of the pilot signal refers to the terminal receiving the pilot signal through receive beams directed in different directions, measuring the magnitude of the pilot signal received through the receive beams, and matching the transmission and reception beams to set the transmit/receive beam indices based on the magnitude of the pilot signal.

The step (S30), in which the terminal sets the optimal receive beam and the base station server sets the optimal transmit beam, refers to the terminal determining the optimal receive beam among the receive beams directed in different directions based on the transmit/receive beam indices, and the base station server receiving the transmit/receive beam index information from the terminal to determine the optimal transmit beam among the transmit beams directed in different directions, thereby forming a channel between the base station server and the terminal.

FIGS. 6 to 8 are diagrams illustrating detailed steps of some of the stages of the communication channel formation method shown in FIG. 5.

Referring to FIG. 6, the communication channel formation method may include: a step (S11) in which the pilot signal is transmitted using a phase shifter and a real-time delay unit, and a step (S12) in which at least one of the direction and the strength of the transmission beams is calibrated using a calibrator.

The step (S11), where the pilot signal is transmitted using a phase shifter and a real-time delay unit, may include transmitting the pilot signal via transmission beams directed in different directions using the real-time delay unit of the time delay part and the phase shifter of the analog part of the base station server. For example, in step (S11), the base station server may control the phase of the transmission beam using the phase shifter and transmit multiple transmission beams with different phases using the real-time delay unit.

The step (S12), in which at least one of the direction and the strength of the transmission beams is calibrated using a calibrator, may include calibrating at least one of the direction and strength of the transmission beams directed in different directions using the real-time delay unit of the calibration unit in the base station server.

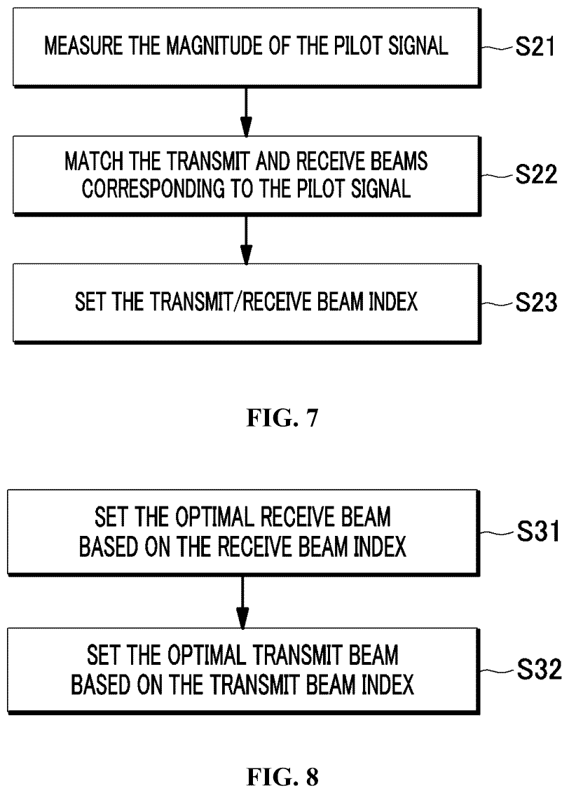

Referring to FIG. 7, the step (S20) in which the terminal sets the transmit/receive beam indices based on the magnitude of the pilot signal may include: a step (S21) of measuring the magnitude of the pilot signal, a step (S22) of matching the transmission and reception beams corresponding to the pilot signal, and a step (S23) of setting the transmit/receive beam indices.

The step (S21) of measuring the magnitude of the pilot signal may be a step in which the terminal measures the magnitude of the received pilot signal. In the step (S21), the terminal may measure the magnitude of the pilot signal received from the base station server based on a predetermined mathematical formula.

The step (S22) of matching the transmission and reception beams corresponding to the pilot signal may be a step in which the terminal matches the transmission beam corresponding to the pilot signal with the reception beam that received the pilot signal, thereby forming a pair of transmit/receive beams. For example, in step (S22), the terminal may match the reception beam that received pilot signal H with the transmission beam of the base station server that transmitted pilot signal H to form a pair of transmit/receive beams.

The step (S23) of setting the transmit/receive beam indices may be a step in which the terminal sets the indices of the transmit/receive beams based on the magnitude of the pilot signal in the reception beam. For example, in step (S23), the terminal may set the index of the transmit/receive beam with the largest pilot signal magnitude.

Referring to FIG. 8, the step (S30) in which the terminal sets the optimal receive beam and the base station server sets the optimal transmit beam may include: a step (S31) of setting the optimal receive beam based on the receive beam index, and a step (S32) of setting the optimal transmit beam based on the transmit beam index.

The step (S31) of setting the optimal receive beam based on the receive beam index may be a step in which the terminal sets the receive beam directed in the direction corresponding to the receive beam index among the transmit/receive beam indices as the optimal receive beam. For example, in step (S31), the terminal may set the receive beam directed in the direction corresponding to the receive beam index among the transmit/receive beam indices with the largest pilot signal as the optimal receive beam.

The step (S32) of setting the optimal transmit beam based on the transmit beam index may be a step in which the terminal transmits the transmit beam index among the transmit/receive beam indices to the base station server, and the base station server sets the transmit beam directed in the direction corresponding to the received transmit beam index as the optimal transmit beam. For example, in step (S32), the terminal transmits the transmit beam index of the transmit/receive beam index with the largest pilot signal to the base station server, and the base station server sets the beam in the corresponding direction as the optimal transmit beam.

The terminal may establish a channel between the base station server and the terminal based on the optimal transmit beam and the optimal receive beam.

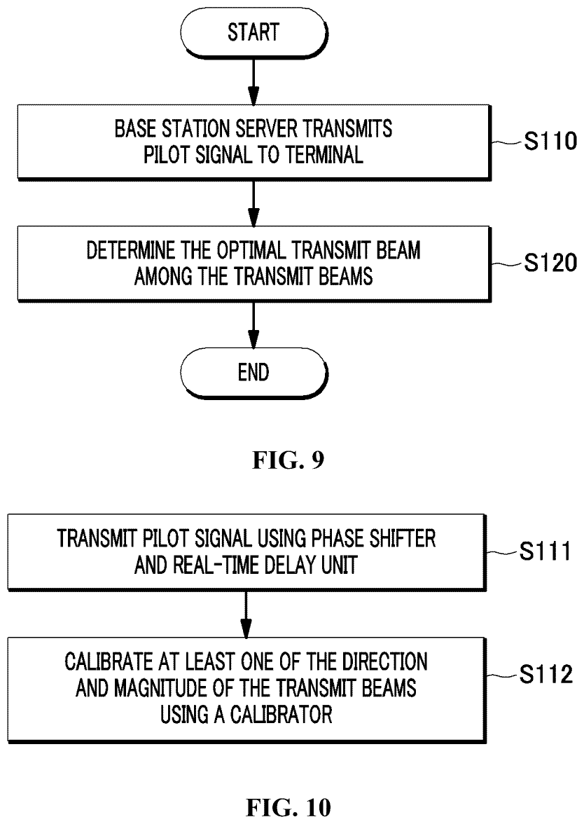

FIG. 9 is a flowchart illustrating the sequence of a communication channel formation method of a base station server in a communication channel formation system according to another embodiment of the present invention.

The communication channel formation method described below may be performed by the base station server (100 in FIG. 1) described with reference to FIGS. 1 to 4. Accordingly, the contents of the embodiments of the present invention described with reference to FIGS. 1 to 4 may equally apply to the embodiments described below, and repeated descriptions will be omitted. The steps described below are not necessarily performed in the stated order; the order of the steps may be rearranged in various ways, and the steps may also be performed almost simultaneously.

Referring to FIG. 9, the communication channel formation method may include a step (S110) in which the base station server transmits a pilot signal to the terminal, and a step (S120) in which the optimal transmission beam is determined among the transmission beams.

The step (S110) in which the base station server transmits a pilot signal to the terminal is a step in which the base station server transmits a pilot signal to the terminal through transmission beams directed in different directions. For example, in the step (S110), the base station server may transmit the pilot signal to the terminal through transmission beams directed in different directions using a phase shifter and a real-time time delay unit. Additionally, in the step (S110), the base station server may calibrate at least one of the direction and magnitude of the transmission beams using the real-time time delay unit.

The step (S120) of determining the optimal transmission beam among the transmission beams may be a step in which the base station server sets the transmission beam directed in the direction corresponding to the transmission beam index among the transmit/receive beam indices received from the terminal as the optimal transmission beam. Here, the index information may be the transmit/receive beam index set based on the magnitude of the pilot signals, measured by the terminal through reception beams directed in different directions, and matched with the transmission beams.

FIG. 10 illustrates detailed steps of some of the steps of the communication channel formation method shown in FIG. 9.

Referring to FIG. 10, the step (S110) in which the base station server transmits a pilot signal to the terminal may include a step (S111) of transmitting the pilot signal using a phase shifter and a real-time time delay unit, and a step (S112) of calibrating at least one of the direction and magnitude of the transmission beams using a calibrator.

The step (S111) of transmitting the pilot signal using a phase shifter and a real-time time delay unit may be a step in which the base station server transmits the pilot signals through transmission beams directed in different directions using the real-time time delay units of the time delay unit and the phase shifters of the analog unit. For example, in the step (S111), the base station server may control the phase of the transmission beam using the phase shifter and may transmit multiple transmission beams with different phases using the real-time time delay unit.

The step (S112) of calibrating at least one of the direction and magnitude of the transmission beams using a calibrator may be a step in which the base station server calibrates at least one of the direction and magnitude of the transmission beams directed in different directions using the real-time time delay units of the calibration unit.

A person of ordinary skill in the art to which the present disclosure pertains will understand, based on the above description, that various other specific forms can be easily modified without altering the technical spirit or essential features of the present disclosure. Therefore, the above-described embodiments should be understood as illustrative in every respect and not limiting. The scope of the present disclosure is indicated by the claims described below, and all modifications or altered forms derived from the meanings, scope, and equivalent concepts of the claims should be interpreted as being within the scope of the present disclosure. The scope of the present application should be determined by the following claims rather than the foregoing detailed description, and all modifications or alterations derived from the meanings, scope, and equivalents of the claims should be construed as included within the scope of the present application.

The embodiment for carrying out the invention is substantially the same as the best mode for carrying out the invention described above.

Since the present invention can be utilized in technologies for forming a channel between a server and a terminal, it has industrial applicability.

What is claimed is:

1. A method for forming a communication channel performed by a base station server and a terminal, the method comprising:
a) transmitting, by the base station server, a pilot signal to the terminal through transmission beams directed in different directions;
b) receiving, by the terminal, the pilot signal through reception beams directed in different directions, measuring the magnitude of the pilot signal received through the reception beams directed in the different directions, and setting transmission-reception beam indices for each magnitude of the pilot signal by matching the transmission beams and the reception beams; and
c) determining, by the terminal, an optimal reception beam among the reception beams directed in different directions based on the transmission-reception beam indices, and determining, by the base station server, an optimal transmission beam among the transmission beams directed in different directions based on the transmission-reception beam index information received from the terminal, thereby forming a channel between the base station server and the terminal.

2. The method of claim 1,
wherein the base station server comprises a phase shifter and a real-time time delay unit,
and in step a), the base station server transmits the pilot signals respectively through the transmission beams directed in the different directions by using the phase shifter and the real-time time delay unit.

3. The method of claim 1,
wherein the base station server comprises a calibrator,
and in step a), the base station server calibrates at least one of a direction and a magnitude of the transmission beams directed in the different directions by using the calibrator.

4. The method of claim 1,
wherein step b) comprises:
b-1) measuring, by the terminal, the magnitude of the pilot signal;
b-2) matching, by the terminal, the transmission beam corresponding to the pilot signal and the reception beam that received the pilot signal to form a pair of transmission-reception beams; and
b-3) setting, by the terminal, an index of the transmission-reception beam based on the magnitude of the pilot signal received by the reception beam.

5. The method of claim 1,
wherein step c) comprises:
c-1) setting, by the terminal, the reception beam directed in the direction corresponding to the reception beam index among the transmission-reception beam indices as the optimal reception beam; and
c-2) setting, by the base station server, the transmission beam directed in the direction corresponding to the transmission beam index among the transmission-reception beam indices received from the terminal as the optimal transmission beam.

6. A communication channel forming system comprising a base station server and a terminal,
wherein the base station server transmits a pilot signal to the terminal through transmission beams directed in different directions,
the terminal receives the pilot signal through reception beams directed in different directions, measures the magnitude of the pilot signal received through the reception beams directed in the different directions, and sets transmission-reception beam indices for each magnitude of the pilot signal by matching the transmission beams and the reception beams,
the terminal determines an optimal reception beam among the reception beams directed in the different directions based on the transmission-reception beam indices, and the base station server receives the transmission-reception beam index information from the terminal and determines an optimal transmission beam among the transmission beams directed in the different directions, such that a channel is formed between the base station server and the terminal.

7. The system of claim 6,
wherein the base station server comprises a phase shifter and a real-time time delay unit,
and the base station server transmits the pilot signals respectively through the transmission beams directed in the different directions by using the phase shifter and the real-time time delay unit.

8. The system of claim 6,
wherein the base station server comprises a real-time time delay unit,
and the base station server calibrates at least one of a direction and a magnitude of the transmission beams directed in the different directions by using the real-time time delay unit.

9. The system of claim 6,
wherein the terminal measures the magnitude of the pilot signal, matches the transmission beam corresponding to the pilot signal and the reception beam that received the pilot signal to form a pair of transmission-reception beams, and sets an index of the transmission-reception beam based on the magnitude of the pilot signal received by the reception beam.

10. The system of claim 6,
wherein the terminal sets the reception beam directed in the direction corresponding to the reception beam index among the transmission-reception beam indices as the optimal reception beam,
and the base station server sets the transmission beam directed in the direction corresponding to the transmission beam index among the transmission-reception beam indices received from the terminal as the optimal transmission beam.

11. A communication channel forming method performed by a base station server, comprising:
a) transmitting a pilot signal to a terminal through transmission beams directed in different directions; and
b) receiving index information formed by a terminal in communication with the base station server, determining an optimal transmission beam among the transmission beams directed in the different directions based on the index information, and forming a channel between the base station server and the terminal,
wherein the index information includes transmission-reception beam indices set based on the magnitude of the pilot signal received by the terminal through reception beams directed in the different directions by matching the transmission beams and the reception beams.

12. The method of claim 11,
wherein the base station server includes a phase shifter and a real-time time delay unit,
and in step a), the base station server transmits the pilot signals respectively through the transmission beams directed in different directions using the phase shifter and the real-time time delay unit.

13. The method of claim 11,
wherein the base station server includes a calibrator,
and in step a), the base station server calibrates at least one of a direction and a magnitude of the transmission beams directed in different directions using the calibrator.

14. The method of claim 11,
wherein the index information includes a transmission-reception beam index that is set by the terminal by measuring the magnitude of the pilot signal, matching the transmission beam corresponding to the pilot signal with the reception beam that received the pilot signal, and setting the index based on the magnitude of the pilot signal received by the reception beam.

15. The method of claim 11,
wherein in step b), the base station server sets the transmission beam directed in the direction corresponding to the transmission beam index among the transmission-reception beam indices received from the terminal as the optimal transmission beam.

16. A base station server of a communication channel forming system, comprising:
a communication module for transmitting and receiving information with a terminal;
a memory for storing a communication channel forming program; and
a processor for executing the communication channel forming program,
wherein the base station server is configured to transmit a pilot signal to the terminal through transmission beams directed in different directions, receive index information formed by the terminal in communication with the base station server, and determine an optimal transmission beam among the transmission beams directed in different directions based on the index information, thereby forming a channel between the base station server and the terminal,
wherein the index information includes transmission-reception beam indices set based on the magnitude of the pilot signal received by the terminal through reception beams directed in the different directions by matching the transmission beams and the reception beams.

17. The base station server of claim 16,
wherein the base station server includes a phase shifter and a real-time time delay unit,
and the processor is configured to transmit the pilot signals respectively through the transmission beams directed in the different directions using the phase shifter and the real-time time delay unit.

18. The base station server of claim 16,
wherein the base station server includes a calibrator,
and the processor is configured to calibrate at least one of the direction and the magnitude of the transmission beams directed in different directions using the calibrator.

19. The base station server of claim 16,
wherein the index information includes a transmission-reception beam index that is set by the terminal by measuring the magnitude of the pilot signal, matching the transmission beam corresponding to the pilot signal with the reception beam that received the pilot signal, and setting the index based on the magnitude of the pilot signal received by the reception beam.

20. The base station server of claim 16,
wherein the processor is configured to set the transmission beam directed in the direction corresponding to the transmission beam index among the transmission-reception beam indices received from the terminal as the optimal transmission beam.
